(19) United States
(12) Patent Application Publication
(10) Pub. No.: US 2017/0336767 A1
(43) Pub. Date: Nov. 23, 2017

(54) HVAC Control

(71) Applicant: Gregory Chabra, JR., Pittsburgh, PA (US)

(72) Inventor: Gregory Chabra, JR., Pittsburgh, PA (US)

(21) Appl. No.: 15/599,423

(22) Filed: May 18, 2017

Related U.S. Application Data
(60) Provisional application No. 62/338,656, filed on May 19, 2016.

(51) Int. Cl. G05B 15/02; F24F 11/00; G05D 23/00

(52) U.S. Cl. CPC G05B 15/02; F24F 11/006; G05B 2219/31156; F24F 2011/0071; F24F 2011/0057; G05D 23/00; G05B 2219/2642

(57) ABSTRACT

An intercept device for HVAC controls that allows for overrides of local settings, either by onboard processing and storage, or by networked communication with on-premise or off-premise control mechanisms or cloud services. The existing thermostat may be mounted directly to the intercept device, or the intercept device may be located at any other location along the control line between the existing thermostat and the controlled equipment, allowing for retention of the original thermostats interface, controls, and aesthetics. The HVAC control intercept may also incorporate wired or wireless networking functions, and additional onboard controls and displays to allow for direct adjustment of the intercept device settings and operational mode.

### CROSS-REFERENCE TO RELATED APPLICATION

This application claims the benefit of U.S. Provisional Application No. 62/338,656 filed May 19, 2016.

### FIELD

The field is that of thermostats. One common embodiment of a thermostat is a wall-mounted device with a rotary, slide, or touch control to set the desired temperature settings. More particularly, the field is that of devices to provide additional functions, such as programmable overrides, to existing thermostats or HVAC systems.

### BACKGROUND

Basic non-programmable thermostats provide calls for heating, cooling, fan control, etc to HVAC systems, but do not allow for programmability or ‘smart home’ integration.

Programmable thermostats allow for scheduled calls, but do not allow for ‘smart home’ integration.

‘Smart’ thermostats allow for scheduled calls, and allow for ‘smart home’ integration, but these devices fully replace existing thermostats rather than enhancing the function of existing thermostats.

None of these examples provide for intercepting calls for heating or cooling by existing thermostats and processing the information with ‘smart home’ services that the original thermostats did not originally possess at the time of manufacture or installation.

### SUMMARY

This document describes a thermostat intercept device, whose embodiments may incorporate wired or wireless data connectivity; power connectivity, supply, and/or battery; and controls and/or sensors to enhance the functions of existing thermostat circuits. Embodiments install in the thermostat circuit between the existing thermostat and the HVAC system(s), and stores settings and/or programming that may be configured via on-device controls, or remotely across network connections.

### BRIEF DESCRIPTION OF THE DRAWINGS

FIG. 1 is a line drawing of a common thermostat;

FIG. 2 is a line drawing of one embodiment;

FIG. 3 is a diagram of an installation example of one embodiment;

FIG. 4 is another view of an installation example of one embodiment;

FIG. 5 is a line drawing of another embodiment;

FIG. 6 is a diagram of another installation example of an embodiment;

FIG. 7 a line drawing of another embodiment;

FIG. 8 is a diagram of another installation example of an embodiment;

FIG. 9 is a line drawing of another embodiment;

FIG. 10 is a flowchart demonstrating an example logic flow of an installation of an embodiment

FIG. 11 is a line drawing of additional embodiments

### DETAILED DESCRIPTION

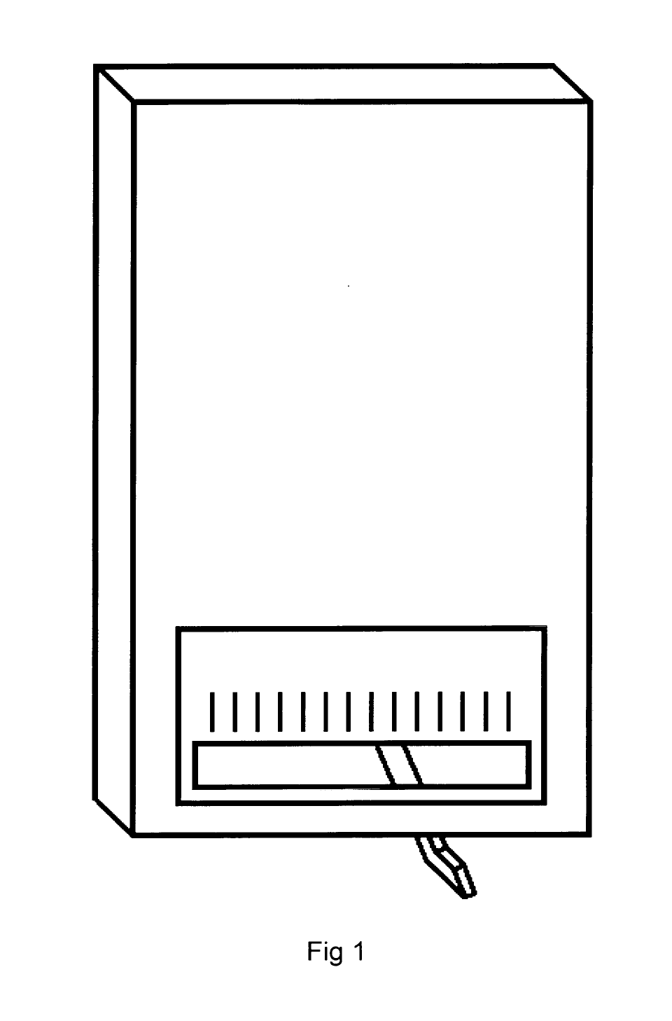

In FIG. 1 there is shown an example of a common embodiment of a thermostat. This example thermostat comprises a housing, a lever protruding from a housing opening for adjustment of the temperature setting, a slot to view the position of the adjustment lever, a series of markings to indicate the temperature setting, a temperature sensor, supporting circuitry or components for processing the settings and sensor information, provisions for connection to the building HVAC wiring, and provisions for wall mounting of the complete assembly.

In more detail, still referring to FIG. 1, common thermostat embodiments produce ‘calls’ for one or more of heating, cooling, fan operation, and other HVAC functions as appropriate for the thermostat settings and current climate conditions. These calls are communicated to the HVAC system via the HVAC thermostat wiring. For clarity, this document will refer to the overall status (calls or absences of calls) as the ‘thermostat state’.

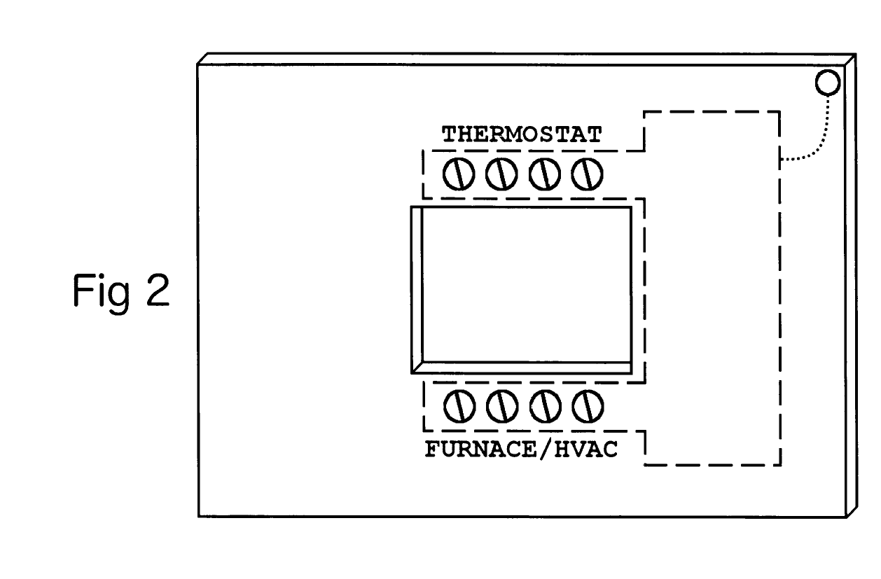

Referring now to the HVAC Control in more detail, in FIG. 2 there is shown an embodiment. This embodiment is a surface-mount panel intended for installation between existing thermostats and the wall of the building structure.

In more detail, still referring to FIG. 2, the embodiment has one or more circuit(s), represented here by the dashed outline. The circuit(s) may be mounted on the front or rear of, or embedded within, the embodiment as appropriate for the specific application. Said circuit(s) include or connect one or more of any combination of component(s) including power supply(s), network component(s), sensor(s), display(s), control(s), and/or transducer(s). Components may be mounted behind, within, to the surface of, or penetrate the embodiment material as appropriate for the specific application.
a. Power supply(s) may each be on-device supply(s) (e.g. battery(s), capacitor(s), photovoltaic(s) etc), connection(s) to off-device supply(s) (e.g. home A/C power, home low-voltage wiring, connection to Power-Over-Ethernet, power obtained from existing HVAC wiring, etc), or methods of deriving power from ambient source(s) (e.g. photovoltaic(s), inductive pickup(s), EM spectrum harvester(s), thermal change power generator(s), etc).
b. Network components may include hardware such as antennas, ports, transmitters, etc as appropriate for the specific application. Supporting circuitry or components may be present to provide for common network functions such as DHCP, DNS, HTTP, FTP, encryption, or other services appropriate for the specific application. One or more network type(s) may be employed depending upon the specific application. Network type(s) may each be wireless (e.g. Wi-Fi, Li-Fi, ZigBee, Z-Wave, bluetooth, RF, IR, passive/low power wireless implementations, proprietary wireless protocol(s), etc) or wired (e.g. ethernet, data-over-powerline, serial port, etc) as appropriate for the specific application.
c. Sensor(s), if present, may each be any of a variety of types, including temperature, motion, proximity, IR, light, humidity, sound, vibration, touch, RF, or any other types of sensor(s). Sensor(s) may penetrate the surface of the embodiment material to gather information from the exposed surface. Said sensors may be used for environmental monitoring, occupancy detection, or any other function as appropriate for the specific application.
d. Display(s), if present, may provide visual feedback of circuit(s) or overall system status. Display(s), if present, may each be of any configuration(s) including single indicator light(s), segmented display(s), bitmapped display(s), or any other configuration(s). Display(s) , if present, may each be of any type(s) including LED, LCD, OLED, EL, or any other type(s).
e. Control(s), if present, may each be any of a variety of types, including mechanical toggle switch, pushbutton switch, touch-sensitive control, rotary control, slider, temperature sensor, motion sensor, proximity sensor, IR sensor, light sensor, humidity sensor, sound sensor, vibration sensor, or any other types of control(s).
f. Transducer(s), if present, may each be any of a variety of types, including voice coil, piezo, or any other types of transducer(s).

In more detail, still referring to FIG. 2, the embodiment has provisions for connecting one or more existing thermostat(s), and additional set of provisions for one or more household HVAC circuit(s). There may be any number of connections as appropriate for the specific application. In this embodiment, these are screw terminals, represented by the circles with diagonal lines; other embodiments may have contacts, pins, sockets, or other connection types as appropriate for the application. Further, while this embodiment shows four connection points per external connection, more or less connections may be employed as appropriate for the application.

In more detail, still referring to FIG. 2, this embodiment has a temperature sensor, represented here by the circle at the top-right corner of the drawing, and connected to the circuit(s) with wiring represented here by the curved dotted line. Other embodiments may have other types of components, such as switch(s), display(s), transducer(s), etc as appropriate for the specific application.

In more detail, still referring to FIG. 2, the circuit(s) serve to detect the state of the existing thermostat, read data and/or settings from the I/O components, transmit/receive data with network or cloud services, process data locally or remotely, and issue commands to cloud services, local network devices, and/or the heating and/or cooling system(s) as appropriate, either by transmitting network commands, or issuing calls on the HVAC wiring.

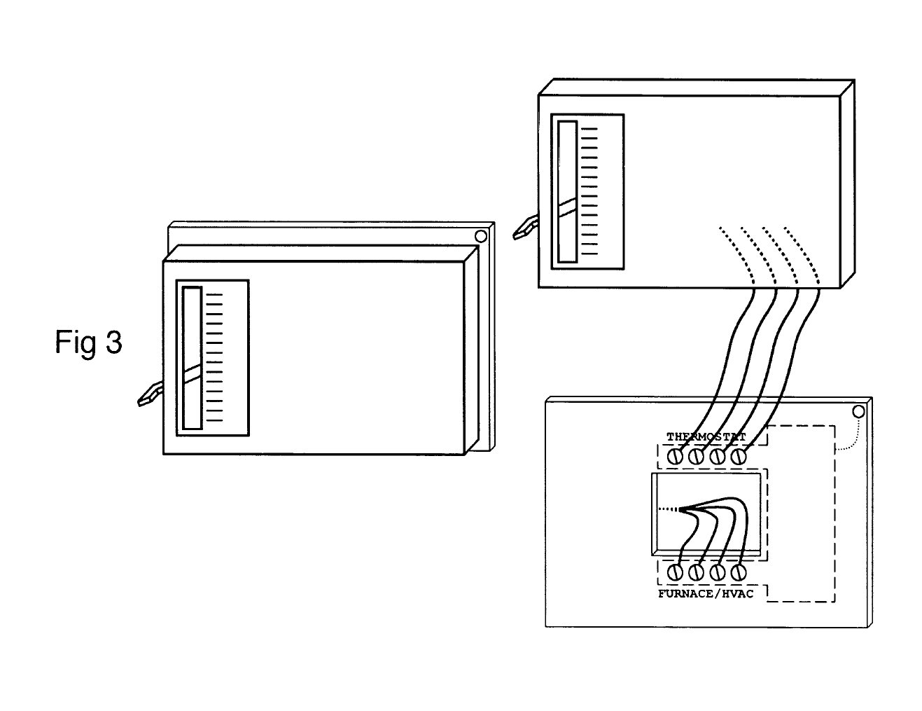

In more detail, now referring to FIG. 3, there is shown a line drawing of one installation option for an embodiment. In this example application, the existing thermostat (top left) is removed from the wall and disconnected from the existing home HVAC wiring. The embodiment (top right) is then mounted on the wall in the original thermostat location, and is connected to the existing home HVAC wiring, represented here by the curved lines connected to the ‘FURNACE/HVAC’ terminals and entering the wall through the opening in the embodiment. The original thermostat is then connected to the embodiment's thermostat terminals via jumper wires, represented by the curved lines connecting the ‘THERMOSTAT’ terminals to the original thermostat. Finally, the existing thermostat is mounted directly upon the embodiment as shown in the bottom line drawing.

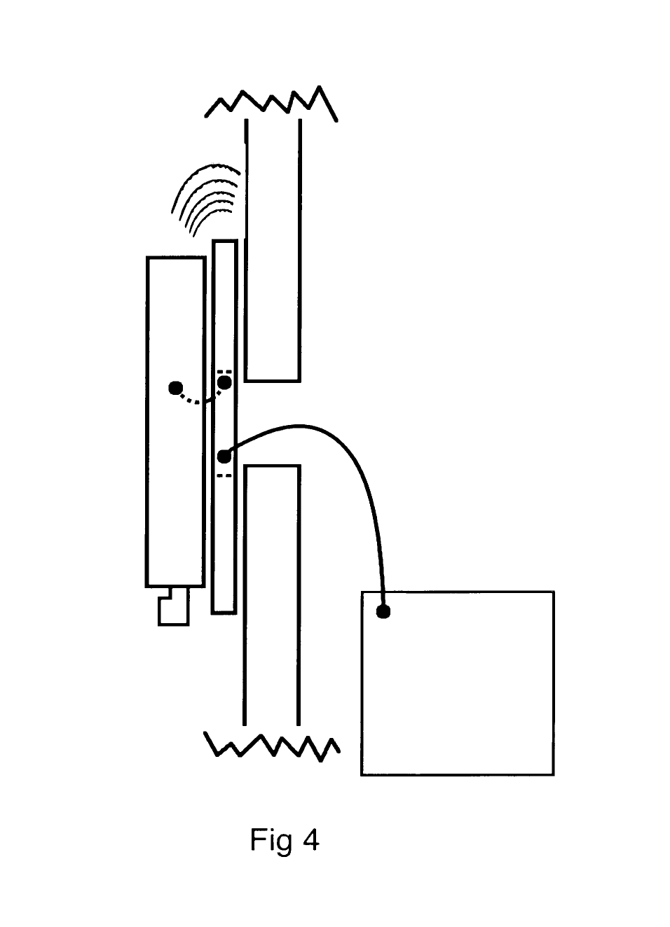

In more detail, Now referring to FIG. 4, there is shown a line drawing of a side view of the embodiment from FIG. 2, installed as described in FIG. 3. The image depicts, from left to right: The original thermostat; wiring connecting the original thermostat to the embodiment; the embodiment; wiring connecting the embodiment to the home HVAC system; the wall upon which the embodiment is mounted, with the opening for wiring; and the the existing home HVAC system is represented by the square.

In more detail, still referring to FIG. 4, the embodiment communicates with a wireless networking connection represented by the concentric arcs above the embodiment, enabled by network connection components in the embodiment circuitry. Note that various embodiments may use other means of connectivity (ethernet, data-over-powerline, infrared, etc).

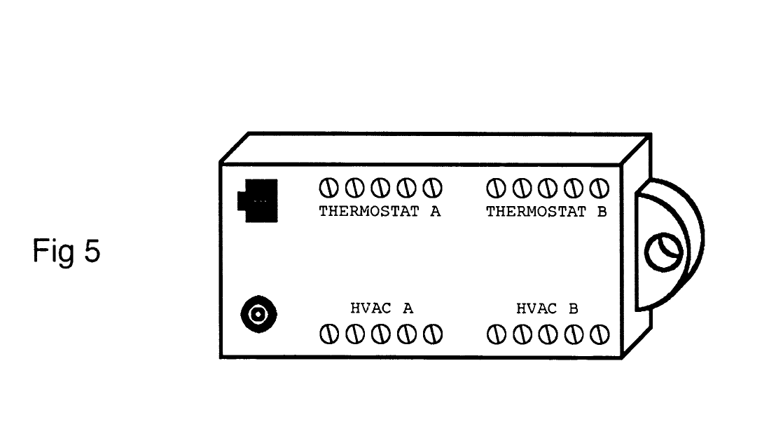

In more detail, in FIG. 5 there is shown a line drawing of another embodiment. This embodiment is intended for installation within a structure cavity, or as a surface-mounted device on a wall surface or directly upon HVAC equipment.

In more detail, still referring to FIG. 5, this embodiment has multiple sets of connections for use with zoned HVAC systems.

In more detail, still referring to FIG. 5, this embodiment includes an ethernet port at the bottom left for connectivity, and a power jack at the bottom right for connection to a wall transformer. Component and connection locations may be arranged in any configuration on different embodiments as appropriate for the specific application.

In more detail, still referring to FIG. 5, this embodiment includes one or more mounting mechanisms for mounting to surfaces. In this illustration there is a single mounting provision at the top of the embodiment, but there may be any configuration of mounting options as appropriate for the specific application.

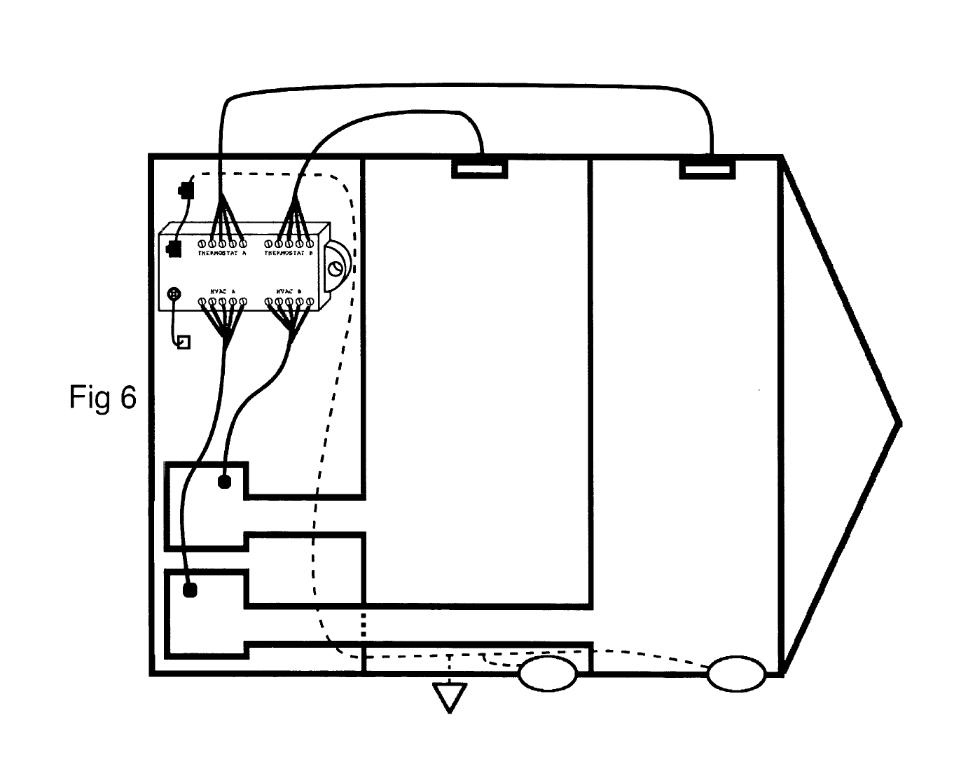

In more detail, now referring to FIG. 6, there is shown an example application of the embodiment from FIG. 5. This illustration depicts a structure with two climate control zones. In this installation example, the original thermostats (represented by rectangles on the left interior walls of the building) are left undisturbed in their original installation locations. The embodiment in this example is installed at a location between the thermostat(s) and termination of wiring at the heating and/or cooling system(s) of the dwelling (represented by the squares in the bottom left of the illustration). Connection is achieved either by splicing into the existing thermostat wiring (represented by curved solid lines), or by removing the connections from the HVAC system(s), connecting them to the embodiment, and installing jumper wires between the embodiment and the HVAC system(s).

In more detail, still referring to FIG. 6, the existing thermostats have four wires connected to the embodiment, and the embodiment has five wires connected to the HVAC systems. In this manner, the embodiment may provide for enhanced control or functionality not provided by the existing thermostats (such as calls for cooling) or to allow for upgraded HVAC systems without replacement of the existing thermostats.

In more detail, still referring to FIG. 6, the embodiment's power connector is connected with wiring (curved solid line) to building power (represented here by the square at the termination of the power wire). Note that other embodiments or installations may obtain power in other methods, such as directly from the HVAC building wiring, by power-over-ethernet, or other means.

In more detail, still referring to FIG. 6, the embodiment's network port is connected with a network cable (curved solid line) to the building's structured network jack (bottom left of drawing). Note that other embodiments or installations may connect to network services by other means, such as wireless networks, cellular data plans, or other methods.

In more detail, still referring to FIG. 6, there is shown example exterior ventilation devices, represented here by the ovals on the right side of the structure. These example ventilation devices may be through-wall fans, whole house ventilation fans, or other systems. These devices derive power from building wiring (omitted from drawing for clarity).

In more detail, still referring to FIG. 6, there is shown an outside temperature sensor, represented by the triangle at the right side of the diagram. This sensor may be powered by any number of means, including solar, building wiring, battery, power-over-ethernet, etc as appropriate for the specific application. While this example shows a locally connected exterior temperature sensor, it is to be understood that this device may alternately be a either a wireless sensor in the vicinity, or an interne service that supplies weather information from a 3rd party service.

In more detail, still referring to FIG. 6, the aforementioned devices communicate with each other across the building's structured network wiring, represented by the curved dashed lines. Note that in other applications, communication may be achieved by other means, such as wireless networks, cellular data plans, or other mechanisms. In this example application, the embodiment is providing all network services for the network (DHCP, HTTP, etc). It is understood that in such networks there are optionally additional devices (not shown) such as network switches, wireless base stations, home control device(s) (such as Alexa, HomeKit, Iris, or bespoke solutions) or other components providing functions and services as appropriate for the specific application.

In more detail, still referring to FIG. 6, the state(s) of the existing thermostat(s) are detected individually by the circuitry within the embodiment. The embodiment also detects the state(s) of other smart home device(s) (in this example the exterior thermostat and ventilation fans) via the network connections as well as the state(s) of the HVAC system(s). The states of all devices are then processed by the settings stored within the embodiment (which may in turn communicate with cloud services for further enhanced control). The states and settings are interpreted by the embodiment, and the resultant command(s) are passed back along the communication chain to the HVAC system(s), exterior ventilation device(s), and/or other device(s) as directed by the programming.

In more detail, still referring to FIG. 6, it is to be understood that this is an example implementation of one embodiment, and that there are numerous alternate installation scenarios and devices. For example, instead of or in addition to exterior ventilation devices, any other type of devices may be controlled, including but not limited to window coverings, automated window openers, ceiling fans, humidifiers, dehumidifiers, electric heating devices, lighting, or any number of other devices as appropriate for the intended installation.

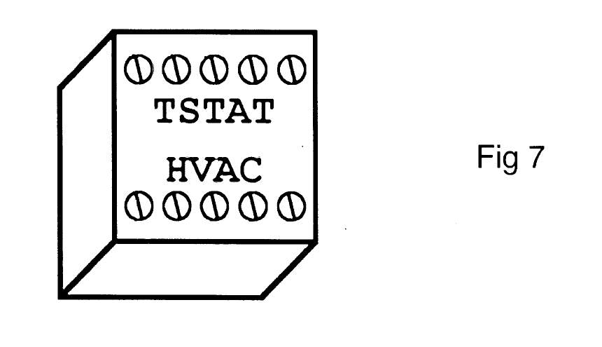

In more detail, in FIG. 7 there is shown a line drawing of another embodiment. This embodiment is of compact dimensions, intended for installation in the wall cavity behind the existing thermostat or at other locations with limited space. In this embodiment, communication is wireless and power is drawn from the HVAC wiring, however it is understood that each type of embodiment may include any or all of the component(s) and function(s) as described elsewhere in this document.

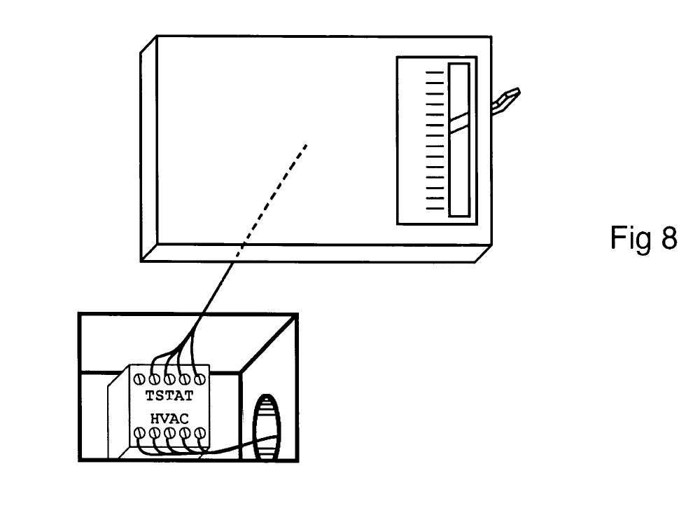

In more detail, in FIG. 8 there is shown a line drawing of an example installation of the embodiment from FIG. 7. In this example application, the original thermostat is first removed from the wall, revealing the wall cavity. The embodiment is then connected to the household HVAC wiring, represented by the curved lines at the left of the embodiment, and to the thermostat with wiring represented by the curved lines at the right of the embodiment. The embodiment is then inserted into the wall cavity before the original thermostat is re-installed to cover the wall cavity. The resultant installation fully conceals the embodiment behind the original thermostat. As with other embodiments, the number and type of connection terminals may be varied as appropriate for the specific application, and not all connections must be used, which allows the embodiment to provide additional signaling and functions not provided by the original thermostat.

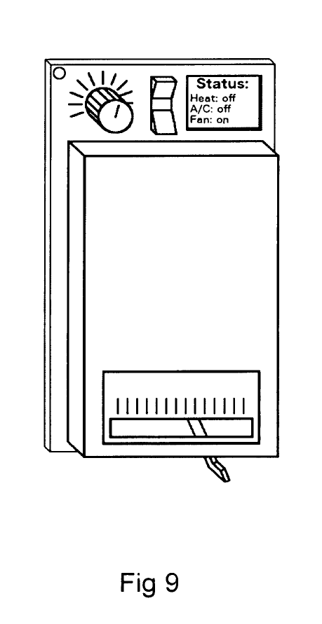

In more detail, in FIG. 9 there is shown an example of an additional embodiment installation. This embodiment demonstrates one implementation of control components for local programming and monitoring of the embodiment, in this case including a knob, a switch, and a digital display. These controls allow for the user to directly adjust the configuration of the embodiment, or to interact with other software or services to adjust the settings of the embodiment. The embodiment may also include functions to control devices other than HVAC equipment. The embodiment is installed on the wall between the original thermostat and the wall cavity in the same manner as the examples from FIG. 3 and FIG. 4.

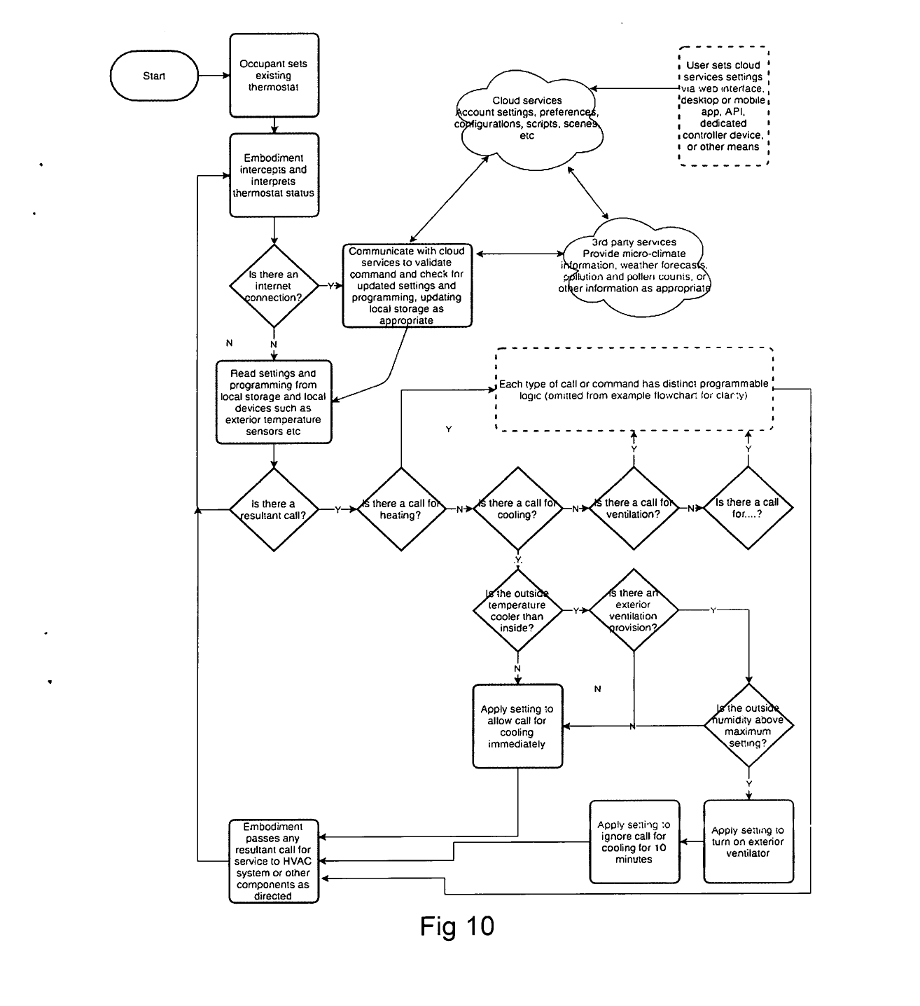

In more detail, now referring to FIG. 10, a simplified partial flowchart is shown for part of the logic used in the previous installation examples. In this example application, the embodiment intercepts and reads the thermostat status; receives settings and preferences from an internet-based cloud services; updates local programming and settings based upon cloud service data; and processes the data according to status, settings, and programming.

In more detail, still referring to FIG. 10, the flowchart is intended to express an example implementation. It is understood that the entire logic of the implementation is programmable to suit the specific installation requirements and preferences, and that such programming may be achieved by numerous methods including but not limited to factory configuration, local configuration via hardware controls, local configuration via network interface (HTTP, FTP, SSH, etc), smartphone or desktop computer app, remote configuration via updates from cloud services, or other mechanisms as appropriate.

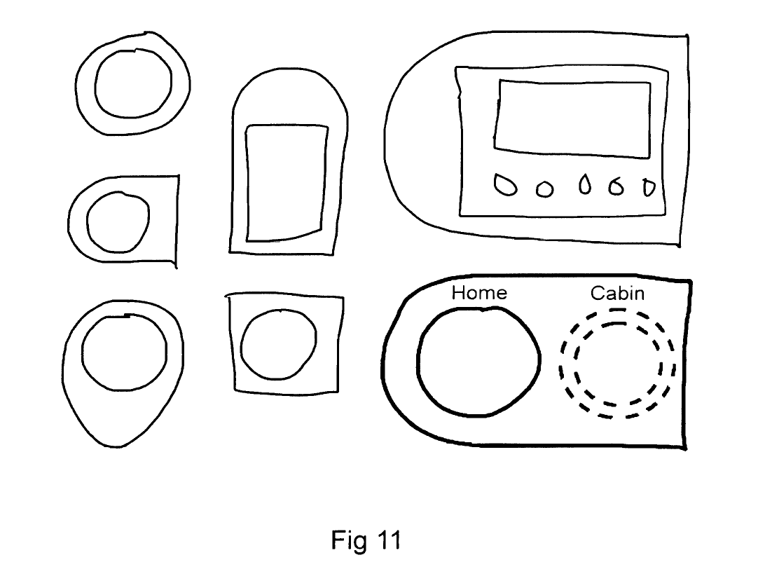

In more detail, in FIG. 11 there are shown additional embodiments. In this figure, the outer outlines are those of the embodiments, and the inner outlines are those of the original thermostats. The top-right drawing demonstrates one application where an existing programmable or smart thermostat is mounted on an embodiment. The bottom-right drawing demonstrates an application where an existing round thermostat is mounted on the embodiment, and the embodiment provides a ‘virtual’ thermostat, represented by the dashed outlines, for monitoring and controlling a remote location. There may optionally be a similar embodiment mounted at the remote location which can similarly control the local location.

In more detail, still referring to FIG. 11, this figure is intended to convey that embodiments may be produced in any dimensions, shape, and appearance as appropriate for the specific application, and can be installed in any number of locations as appropriate for the specific application. Further, embodiments may be created to be compatible with existing controls of various types, shapes, sizes, etc.

The advantages of the HVAC Control may include, without limitation, that it provides for programmable functions in addition to any that the existing thermostat may provide.

In broad embodiment, the HVAC Control is a programmable override for thermostats.

Is it understood that multiple types of embodiments may be installed within a single structure in various combinations to provide for an enhanced network of environment monitoring and control.

While the foregoing written description of the HVAC Control enables one of ordinary skill to make and use what is considered presently to be the best mode thereof, those of ordinary skill will understand and appreciate the existence of variations, combinations, and equivalents of the specific embodiment, method, and examples herein. The HVAC Control should therefore not be limited by the above described embodiments, methods, and examples, but by all embodiments and methods within the scope and spirit of the HVAC Control as claimed. For example, embodiments may employ different wired or wireless protocols, or be utilized in in multi-thermostat applications. It is, therefore, to be understood that the within the scope of the appended claim, the HVAC Control may be practiced otherwise than as specifically described.

What is claimed is:

1. A device, installed between an existing thermostat and the wall, which includes which includes circuitry comprising of HVAC wiring connections, and components including power supply(s), communication component(s), and one or more sensor(s), display(s), control(s), and/or transducer(s); said circuitry and components interpreting the state of the existing thermostat, and performing processing according to local and/or remote logic; issuing commands to the HVAC system or other network components based upon the results of said processing, with the remote commands optionally overriding any local command from the existing thermostat.

2. A device, connected to HVAC wiring between existing thermostat(s) and the HVAC system(s) and mounted at any location along said wiring, which includes circuitry comprising of HVAC wiring connections, and components including power supply(s), communication component(s), and one or more sensor(s), display(s), control(s), and/or transducer(s); said circuitry and components interpreting the state of the existing thermostat(s), and performing processing according to local and/or remote logic; issuing commands to the HVAC system or other network components based upon the results of said processing, with the remote commands optionally overriding any local command from the existing thermostat.

3. A method for intercepting HVAC commands issued by existing thermostats; communicating said commands to other local or remote devices or services; performing processing based upon local and remote commands and programming; and issuing customized commands to the HVAC systems as a result of said processing.
